(19) United States
(12) Patent Application Publication
(10) Pub. No.: US 2018/0238555 A1
(43) Pub. Date: Aug. 23, 2018

(54) A HOUSEHOLD APPLIANCE CONTROL UNIT CONTROLLED BY MEANS OF AN IMAGE REFLECTED BY A PROJECTOR

(71) Applicant: ARCELIK ANONIM SIRKETI, Istanbul (TR)

(72) Inventors: Davut Ayhan SERABATIR, Istanbul (TR); Yalcin OZKAN, Istanbul (TR); Can Onur VANCI, Istanbul (TR)

(21) Appl. No.: 15/772,034

(22) PCT Filed: Nov. 1, 2016
(86) PCT No.: PCT/TR2016/050415

§ 371 Date: Apr. 27, 2018

(30) Foreign Application Priority Data
Nov. 9, 2015 (TR) 2015/14002

(51) Int. Cl. F24C 7/08; F24C 15/20; G03B 21/14

(52) U.S. Cl. CPC F24C 7/082; G03B 21/145; F24C 15/2042; F24C 15/2021

(57) ABSTRACT

The present invention relates to a household appliance control unit comprising a casing and a projector that is placed in the casing, that transmits images preloaded by the producer to a surface and is suitable for enabling the user to input data via the image transmitted and enabling one or more than one household appliance to be controlled according to the data input.

The present invention relates to a household appliance control unit the operation of which is controlled by means of a projector that reflects an image predetermined by the producer for controlling the household appliance on a surface and of a sensor that detects the control signal on the area scanned by the projector.

Nowadays, household appliances can be controlled in a wired or wireless manner by detecting the data input by the user via the image reflected by the projectors on a surface. Especially in cooker and exhaust hood embodiments, the projector is placed inside the exhaust hood; however, due to the operation of the cooker, impurities such as oil, moisture, etc. in the environment stick to and accumulate on the glass in front of the projector, consequently beams emanating from the projector cannot reach the surface on which the image is intended to be reflected or the quality of the image is impaired. Furthermore, the distance between the projector and the surface on which the image is reflected may vary. In this case, the focus setting of the project is required to be adjusted or when a failure occurs in the operation of the projector, the projector requires service.

In the state of the art International Patent Application No. WO2010135478, household appliances which are controlled via an image reflected by a projector are disclosed.

In the state of the art International Patent Application No. WO201078643, a projector placed on an exhaust hood and a cooker controlled via an image reflected by the projector are disclosed.

The aim of the present invention is the realization of a cover that enables a projector concealed in a casing to be serviced.

The household appliance control unit realized in order to attain the aim of the present invention, explicated in the first claim and the respective claims thereof, comprises a projector placed into a casing and an opening/closing cover placed in front of the projector. Thus, by means of the cover the user is prevented from direct access to the projector and the projector can be serviced easily when needed.

In an embodiment of the present invention, an opening is provided on the part of the cover that corresponds to the lens of the projector. The said opening is covered with a transparent plate in the preferred embodiment of the present invention.

An adjustment aperture that provides access to the projector concealed in the casing without removing the cover is provided on the cover. By means of the said adjustment aperture, the projector can be accessed with a finger or an extension so that characteristic settings of the projector (such as focus setting, brightness, etc.) can be adjusted.

A lock that provides easy opening and closing of the cover is provided on the cover. After the cover is removed by unlocking the lock, the projector concealed in the casing can be accessed.

In another embodiment of the present invention, the cover is mounted onto the casing by means of a hinge. Thus, the cover is opened without being detached from the casing, thereby enabling the projector to be serviced.

In an embodiment of the present invention, the household appliance control unit controls a cooker and is placed inside an exhaust hood. The project is disposed into the exhaust hood mounted above the cooker.

A household appliance control unit realized in order to attain the aim of the present invention is illustrated in the attached figures where

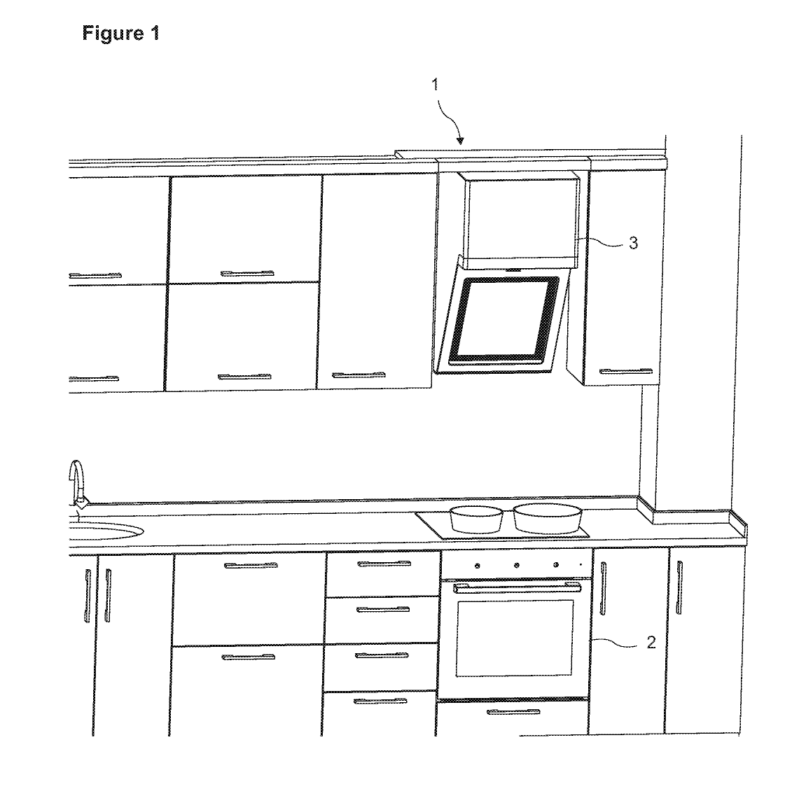

FIG. 1—is the general view of a household appliance control unit.

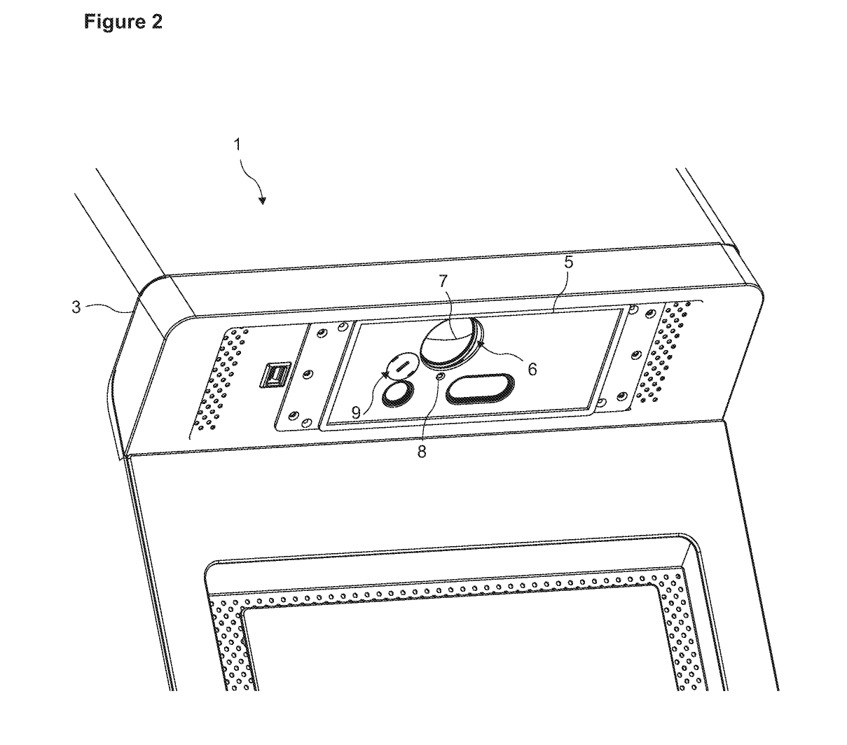

FIG. 2—is the view of the casing and the cover.

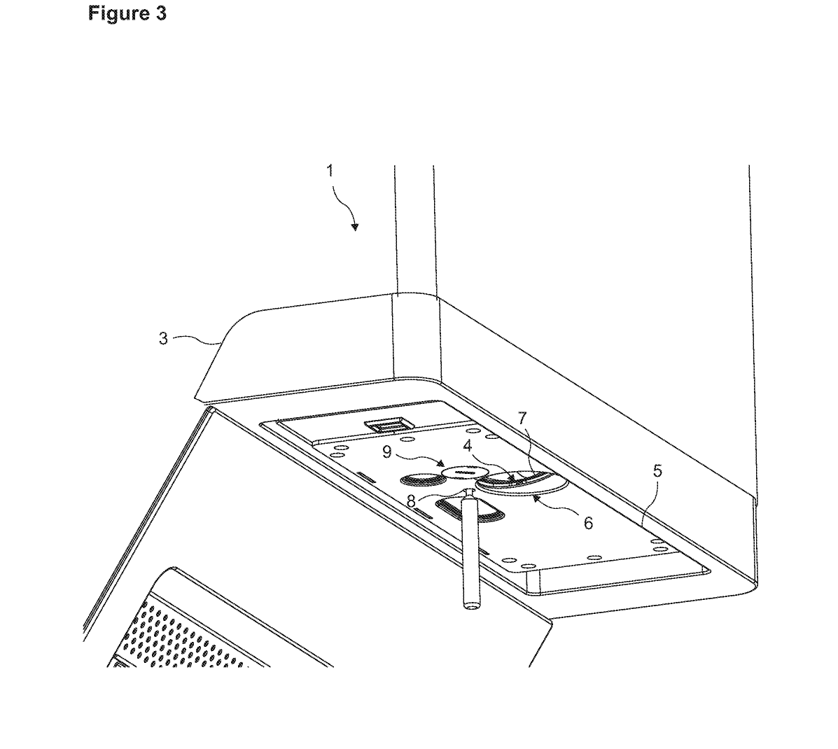

FIG. 3—is the view of the casing and the cover when the projector is adjusted through the cover.

The elements illustrated in the figures are numbered as follows:
1. Household appliance control unit
2. Household appliance
3. Casing
4. Projector
5. Cover
6. Opening
7. Plate
8. Adjustment aperture
9. Lock

The household appliance control unit (1) comprises a casing (3); a projector (4) that is placed in the casing (3), that transmits images preloaded by the producer to a surface and is suitable for enabling the user to input data via the image transmitted and enabling one or more than one household appliance (2) to be controlled according to the data input, and a cover (5)
that is placed in front of the projector (4) and
that provides access to the projector (4) therethrough (FIG. 1).

The cover (5) is placed in front of the projector (4) so that the image delivered by the projector (4) disposed in the casing (3) is not prevented from reaching the surface. When the projector (4) is desired to be serviced due to a failure or for adjusting the focus setting, etc., service can be given through the cover (5). Thus, the user is prevented from direct access to the projector (4) concealed in the casing (3), and the projector (4) is enabled to be accessed through the cover (5). Thereby, the projector (4) is serviced without requiring to detach the projector (4) from the casing (3).

The cover (5) comprises an opening (6) disposed at the part which corresponds to the lens of the projector (4). In the preferred embodiment of the present invention, the said opening (6) is covered with a transparent plate (7). Thus, the image projected from the projector (4) is enabled to be transmitted to the desired surface without refracting or creating any reflections (FIG. 2).

The cover (5) is an opening and closing cover (5). When the projector (4) is desired to be serviced, the cover (5) is detached and after the service operation is finished, the cover (5) is replaced.

The cover (5) comprises an adjustment aperture (8) that provides access to the focus setting adjustment mechanism behind the cover (5) in order to adjust the focus setting of the projector (4). By means of a finger or an extension inserted through the adjustment aperture (8), characteristic settings of the projector (4), such as focus setting, brightness, etc., are adjusted without detaching the cover (5) (FIG. 3).

The cover (5) comprises a lock (9) that provides the open and closed positions of the cover (5) to be controlled by being rotated. By rotating the lock (9), the cover (5) is released and the cover (5) is opened. When the cover (5) is replaced on the casing (3), the lock (9) is rotated again to enable the cover (5) to be locked on the casing (3).

In an embodiment of the present invention, the cover (5) is mounted from one edge thereof by means of a hinge on the casing (3). When opened, the cover (5) opens by swiveling around the said hinge, and when desired to be closed, the cover (5) swivels exactly in the opposite direction and closes on the casing (3).

In the preferred embodiment of the present invention, a cooking device is controlled by means of a household appliance control unit (1) as explicated in the foregoing embodiments. In the preferred embodiment, the cooking device is a countertop cooker. In another version of this embodiment of the present invention, the household appliance control unit (1) is placed inside an exhaust hood. In this embodiment of the present invention, the exhaust hood is mounted above the countertop cooker so that a distance remains between the exhaust hood and the countertop cooker. In this embodiment, the projector (4) disposed in the casing (3) transmits the image on the household appliance (2) or on the surface where the same is placed. In this embodiment, any impurities such as oil, steam, moisture, etc. generated due to the meal cooked on the cooker reach the plate (7) in front of the projector (4) placed in the exhaust hood while being sucked by the exhaust hood. By means of the present invention, while the said impurities are prevented from reaching the projector (4), the user is also prevented from access to the projector (4). Thus, while access of any unauthorized persons to the projector (4) is prevented, the projector (4) is enabled to be easily serviced.

1. A household appliance control unit comprising a casing and a projector that is placed in the casing, that transmits images preloaded by the producer to a surface and is suitable for enabling the user to input data via the image transmitted and enabling one or more than one household appliance to be controlled according to the data input, characterized by a cover
that is placed in front of the projector and
that provides access to the projector therethrough.

2. The household appliance control unit as in claim 1, characterized by the cover comprising an opening at the part that corresponds to the lens of the projector.

3. The household appliance control unit as in claim 2, characterized by the opening that is covered by a transparent plate.

4. The household appliance control unit as in claim 1, characterized by the cover that can be opened and closed.

5. The household appliance control unit as in claim 1, characterized by an adjustment aperture that provides access to the focus setting adjustment mechanism behind the cover in order to adjust the focus setting of the projector.

6. The household appliance control unit as in claim 1, characterized by the cover comprising a lock that provides the open and closed positions of the cover to be controlled by being rotated.

7. The household appliance control unit as in claim 1, characterized by the cover that is mounted from one edge thereof by means of a hinge on the casing.

8. A cooking device controlled by a household appliance control unit as in any claim 1.

9. An exhaust hood wherein a household appliance control unit as in claim 1 is placed.
